(19) United States
(12) Patent Application Publication
(10) Pub. No.: US 2011/0123664 A1
(43) Pub. Date: May 26, 2011

(54) Mold Apparatus

(76) Inventors: Xiaoping Wu, Taipei (TW); Shih-Hsiung Ho, Taipei (TW)

(21) Appl. No.: 12/625,559

(22) Filed: Nov. 25, 2009

(51) Int. Cl. B29C 37/02

(52) U.S. Cl. 425/218

(57) ABSTRACT

A mold apparatus includes a core having a mold cavity for molding an article, a runner formed at one side of the mold cavity and communicated with the mold cavity by a side gate for allowing molten plastics to flow into the mold cavity therefrom. The core further has an angular projection projected into the side gate for forming a cleft between the article and redundant plastics formed in the runner after the molten plastics become cooling, so that the redundant plastics could be easily and rapidly removed from the article along the cleft.

### BACKGROUND OF THE INVENTION

1. Field of the Invention

The present invention relates to a mold apparatus, and more particularly to a mold apparatus which has an improved structure capable of making redundant parts be removed from an article easily and rapidly.

2. The Related Art

In general, a conventional mold apparatus includes a core having a mold cavity for molding an article and a gate connecting the mold cavity and a runner for allowing molten plastics to flow into the mold cavity therefrom.

However, the article molded by the conventional mold apparatus often has redundant parts formed in the runner integrated therewith after molten plastics become cooling. The redundant parts need to be separated from the article with manual operation. That not only wastes a lot of time, but also apt to burr the article easily. And thereafter, it needs to add a process to remove the burrs from the article to guarantee the quality of the article, which virtually increases the cost of the article. Hence, it is desirable to have an improved mold apparatus capable of automatically separating redundant parts from the article without burrs to overcome the problem encountered with the prior art.

### SUMMARY OF THE INVENTION

It is an object of the present invention to provide an improved mold apparatus capable of making redundant parts be removed from an article easily and rapidly. The mold apparatus includes a core having a mold cavity for molding an article, a runner formed at one side of the mold cavity and communicated with the mold cavity by a side gate for allowing molten plastics to flow into the mold cavity therefrom. The core further has an angular projection projected into the side gate for forming a cleft between the article and redundant plastics formed in the runner after the molten plastics become cooling, so that the redundant plastics can be easily removed from the article along the cleft.

As described above, by providing the angular projection projected into the side gate to form the cleft between the article and the redundant plastics after the molten plastic become cooling, the redundant plastics can be easily and rapidly removed from the article along the cleft, and the article is easy to form a smooth surface without burrs thereon.

### BRIEF DESCRIPTION OF THE DRAWINGS

The present invention will be apparent to those skilled in the art by reading the following description of an embodiment thereof, with reference to the attached drawings, in which:

FIG. 1 is a schematic cross sectional view of a mold apparatus in accordance with the present invention with a first core and a second core detached from each other;

FIG. 2 is a cross sectional view showing a mold cavity filled up with molten plastics after the first core and the second core are closed with each other; and

FIG. 3 is a partial enlarged view of an article after it is taken out of the molding cavity;

### DETAILED DESCRIPTION OF THE PREFERRED EMBODIMENT

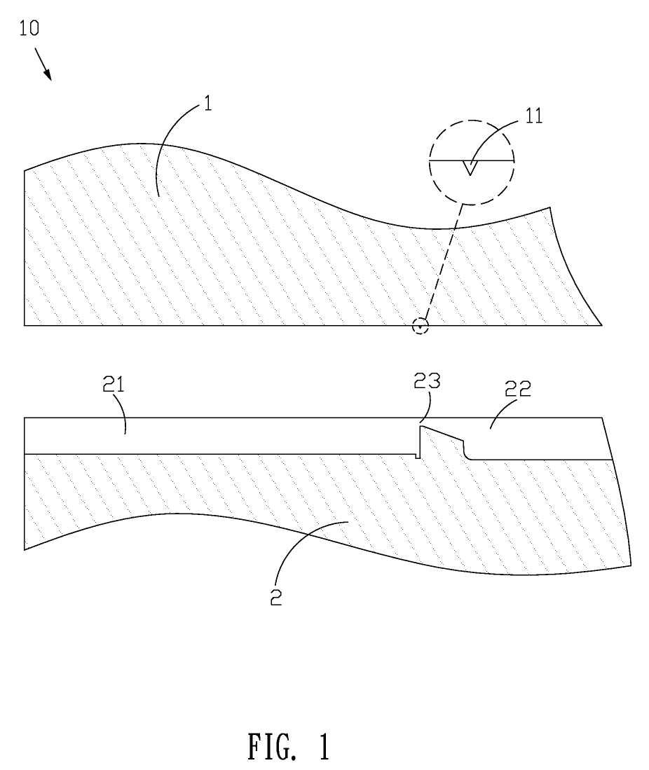

As illustrated in FIG. 1, a mold apparatus 10 according to the present invention includes a first core 1 and a second core 2. The first core 1 has an angular projection 11 formed at a proper position thereof. The second core 2 defines a mold cavity 21 for molding an article, a runner 22 formed at one side of the mold cavity 21 and communicated with the mold cavity 21 by a side gate 23 for allowing molten plastics to flow into the mold cavity 21 therefrom. When the first core 1 and the second core 2 are closed with each other, the mold cavity 21, the runner 22 and the side gate 23 are closed between the first core 1 and the second core 2, the angular projection 11 is projected into the side gate 23 but not close the side gate 23.

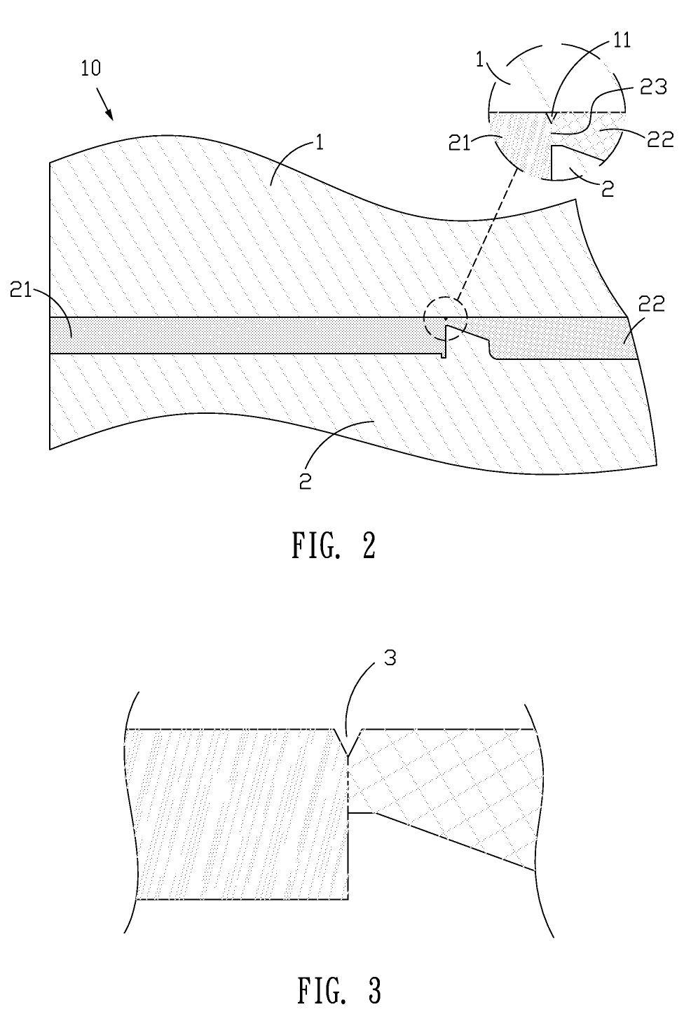

With reference to FIG. 2 and FIG. 3, in molding, molten plastics flow into the mold cavity 21 along the runner 22. After the molten plastics become cooling, the first core 1 and the second core 2 are detached from each other to draw out the angular projection 11 from the side gate 23. The molten plastics in the mold cavity 21 harden to form an article while the molten plastics in the runner 22 harden to form redundant plastics connected to the article with a cleft 3 formed therebetween by the angular projection 11. Therefore, the redundant plastics can be easily removed from the article along the cleft 3, and the article is easy to form a smooth surface without burrs thereon.

As described above, by providing the angular projection 11 projected into the side gate 23 to form the cleft 3 between the article and the redundant plastics after the molten plastic become cooling, the redundant plastics can be easily and rapidly removed from the article along the cleft 3, and the article is easy to form a smooth surface without burrs thereon.

What is claimed is:

1. A mold apparatus, comprising:
a core, the core defining a mold cavity for molding an article, a runner formed at one side of the mold cavity and communicated with the mold cavity by a side gate for allowing molten plastics to flow into the mold cavity therefrom,
wherein the core has an angular projection projected into the side gate for forming a cleft between the article and redundant plastics formed in the runner after the molten plastics become cooling, so that the redundant plastics can be easily removed from the article along the cleft.

2. The mold apparatus as claimed in claim 1, wherein the core includes a first core at which the angular projection formed and a second core at which the mold cavity, the runner and the side gate formed, the angular projection is brought to movably project into the side gate or draw out the side gate when the first core and the second core are closed with or detached from each other.
